(19) United States
(12) Patent Application Publication
(10) Pub. No.: US 2015/0303779 A1
(43) Pub. Date: Oct. 22, 2015

(54) AUXILIARY POWER APPARATUS

(71) Applicant: Chanyong JUNG, (US)

(72) Inventor: Chanyong Jung, Daejeon (KR)

(73) Assignee: Chanyong Jung, Jung-gu, Daejeon (KR)

(21) Appl. No.: 14/235,309

(22) PCT Filed: Feb. 15, 2013
(86) PCT No.: PCT/KR2013/001177

§ 371 Date: Jan. 27, 2014

(30) Foreign Application Priority Data
Nov. 30, 2012 (KR) 20-2012-0011176

(51) Int. Cl. H02K 16/00; H02K 1/27

(52) U.S. Cl. CPC H02K 16/005; H02K 1/27; Y10S 74/09; H02K 53/00

(57) ABSTRACT

Disclosed therein is an auxiliary power apparatus including: a first rotating member including a first magnet having two different poles and rotatably mounted inside the case; a second rotating member including a second magnet having two different poles, the second rotating member being mounted rotatably relative to the first rotating member while surrounding the first rotating member and rotated by receiving a driving force from a motor; and a power transmission member connected with the second rotating member and the first rotating member, and rotatably mounted inside the case so as to transmit the driving power of the motor, which is transmitted to the second rotating member, to the first rotating member. The auxiliary power apparatus can keep the number of revolutions better than the conventional bower apparatus by means of magnetic force (repulsive force and gravitation) acting between a first rotating member and a second rotating member rotating by driving force of a motor.

### TECHNICAL FIELD

The present invention relates to an auxiliary power apparatus, and more particularly to, an auxiliary power apparatus which can keep the number of revolutions better than the conventional power apparatus by means of magnetic force (repulsive force and gravitation) acting between a first rotating member and a second rotating member rotating by driving force of a motor.

### BACKGROUND ART

In general, a power apparatus converts thermal energy using thermal power or electric power using electricity into mechanical energy.

However, such a power apparatus which converts thermal energy using thermal power or electric power using electricity into mechanical energy has to continuously consume thermal energy or electric energy in order to obtain mechanical energy, namely, driving power.

Therefore, recently, according to the green energy policy, studies to obtain energy of high efficiency while consuming less energy have been made.

For instance, Korean Patent No. 10-0872632 discloses a hydraulically regenerative braking and auxiliary power apparatus for a hybrid vehicle which heat-exchanges compressed air of an energy storage tank with unavailable energy discharged from an internal combustion engine so as to expand and compress into an isothermal state, thereby remarkably enhancing energy storage density and efficiency.

Additionally, Korean Patent. Laid-open No. 10-2008-0090247 discloses an auxiliary power apparatus. The auxiliary power apparatus includes: a front disc connected with an input shaft rotating an external force; a cylindrical body having rear disks mounted at both end portions and connected with an output shaft; a plurality of first rotating members respectively mounted on the front surfaces of the front and rear disks of the cylindrical body so as to be eccentrically rotated in accordance with rotation of the cylindrical body; a plurality of second rotating members hinge-coupled with the first rotating members and mounted on the rear surface of the disk; a plurality of third rotating members penetrating through the cylindrical body and joined to the cylindrical body; and a guide member mounted on the outer face of the cylindrical body in order to restrict a radius of rotation when the first rotating members are rotated. Therefore, the auxiliary power apparatus can increase the number of revolutions transferred from the outside so as to improve output and keep a rotary power for a predetermined period of time even though the rotary power is cut off.

However, the conventional auxiliary power apparatuses have several problems in that they have a high level of dependence on wind power energy or electric energy and in that they are complicated in structure and not easy to install and maintain because they are independently mounted to a main power apparatus.

### DISCLOSURE

### Technical Problem

Accordingly, the present invention has been made in an effort to solve the above-mentioned problems occurring in the prior arts, and it is an object of the present invention to provide an auxiliary power apparatus which can keep the number of revolutions better than the conventional power apparatus by means of magnetic force (repulsive force and gravitation) acting between a first rotating member and a second rotating member rotating by driving force of a motor.

It is another object of the present invention to provide an auxiliary power apparatus which is in expensive, durable and economically feasible and has a simple structure.

### Technical Solution

To achieve the above objects, the present invention provides an auxiliary power apparatus including: a first rotating member including a first magnet having two different poles and rotatably mounted inside the case; a second rotating member including a second magnet having two different poles, the second rotating member being mounted rotatably relative to the first rotating member while surrounding the first rotating member and rotated by receiving a driving force from a motor; and a power transmission member connected with the second rotating member and the first rotating member, and rotatably mounted inside the case so as to transmit the driving power of the motor, which is transmitted to the second rotating member, to the first rotating member.

Moreover, the first rotating member includes: a first rotary shaft; a first gear fixed to one end of the first rotary shaft; a first magnet body of a cylindrical shape mounted at one end of the first gear and fixed to the first rotary shaft; and a first magnet having two different poles and being fixed to the outer circumferential surface of the first magnet body.

Furthermore, the second rotating member includes: a second rotary shaft; a second gear fixed to one end of the second rotary shaft; an inertia plate of a disk form fixed to one end of the second gear; a second magnet body of a cylindrical shape mounted between the inertial plate and the second gear and fixed to the second rotary shaft; and a second magnet fixed to the inner circumferential surface of the second magnet body.

Additionally, the power transmission member includes: a third rotary shaft; a third gear fixed at one end of the third rotary shaft; and a fourth gear fixed to the third rotary shaft at one end of the third gear.

### Advantageous Effects

The auxiliary power apparatus according to an exemplary embodiment of the present invention can keep the number of revolutions than the conventional power apparatus by means of magnetic force (repulsive force and gravitation) acting between the first rotating member and the second rotating member rotating by driving force of the motor.

The auxiliary power apparatus ac cording to an exemplary embodiment of the present invention is in expensive, durable and economically feasible and has a simple structure.

### DESCRIPTION OF DRAWINGS

FIG. 1 is a perspective view of an auxiliary power apparatus according to a preferred embodiment of the present device.

FIG. 2 is a plan sectional view of the auxiliary power apparatus.

FIG. 3 is a side sectional view of the auxiliary power apparatus.

### MODE FOR INVENTION

In order to promote rotation by means of a magnetic force including repulsive force and gravitation which interact with each other, a first magnet and a second magnet are all rotatably mounted and are rotatable in the same direction, and the magnet which is more in magnetic force and mass is faster in speed of revolution than the magnet which is less in magnetic force and mass.

Reference will be no made in detail to the preferred embodiment of the present invention with reference to the attached drawings.

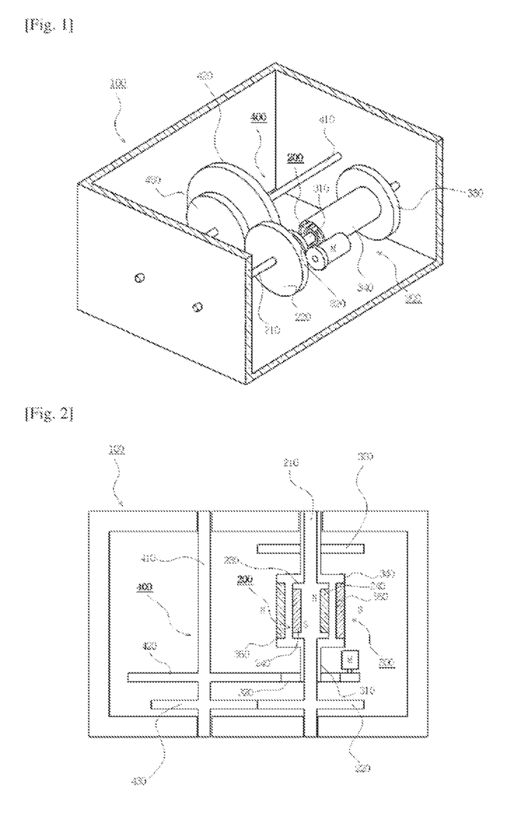

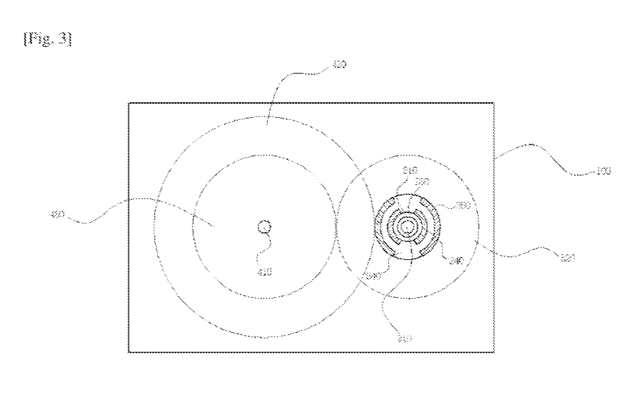

FIG. 1 is a perspective view of an auxiliary power apparatus according to a preferred embodiment of the present device, FIG. 2 is a plan sectional view of the auxiliary power apparatus, and FIG. 3 is a side sectional view of the auxiliary power apparatus.

As shown in FIGS. 1 to 3, an auxiliary power apparatus according to a preferred embodiment of the present invention includes a case 100, a first rotating member 200, a second rotating member 300, and a power transmission member 400.

It is preferable that the case 100 have an empty space therein and be made of a non-conductive material.

The first rotating member 200 has a first magnet 240 having two different poles and rotatably mounted inside the case 100.

The first rotating member 200 includes a first rotary shaft 210, a first gear 220, a first magnet body 230, and a first magnet 240.

The first rotary shaft 210 is a round bar and is rotatably mounted inside the case 100.

The first gear 220 fixed to one end of the first rotary shaft 210, engaged with a fourth gear 430 of the power transmission member 400 which will be described later, such that the first gear 200 is rotated together with the first rotary shaft 210 by receiving rotational energy of the fourth gear 430.

The first magnet body 230 is mounted at one end of the first gear 220 fixed to the first rotary shaft 210, and is formed in a cylindrical shape.

The first magnet 240 has two different poles and is fixed to the outer circumferential surface of the first magnet body 230 in an arc shape.

The second rotating member 300 has a second magnet 350 having two different poles, is mounted rotatably relative to the first rotating member 200 while surrounding the first rotating member 200, and is rotated by receiving a driving force from a motor A which obtains electricity from the outside.

The second rotating member 300 includes a second rotary shaft 310, a second gear 320, an inertial plate 330, a second magnet body 340, and a second magnet 350.

The second rotary shaft 310 is a round bar, surrounds the first rotary shaft 210, and is mounted rotatably on the first rotary shaft 210.

The second gear 320 is fixed to one end of the second rotary shaft 310 and is mounted rotatable on the first rotary shaft 210 which penetrates the second gear 320.

In this instance, it is preferable that the second gear 320 be smaller in diameter than the first gear 220.

The inertia plate 330 is fixed to one end of the second gear 320, is in a disk form, and is mounted rotatable on the first rotary shaft 210 which penetrates the inertial plate 330.

The second magnet body 340 is in a cylindrical shape, is mounted between the inertial plate 330 and the second gear 320, is fixed to the second rotary shaft 310 while surrounding the first magnet body 230 and the first rotary shaft 210, and is mounted rotatably on the first rotary shaft 210.

The second magnet 350 has two different poles, is in an arc shape, and is fixed to the inner circumferential surface of the second magnet body 340.

The power transmission member 400 is connected with the second rotating member 300 and the first rotating member 200, is rotatably mounted inside the case 100 so as to transmit the driving power of the motor A, which is transmitted to the second rotating member 300, to the first rotating member 200.

The power transmission member 400 includes a third rotary shaft 410, a third gear 420, and a fourth gear 430.

The third rotary shaft 410 is a round bar and is rotatably mounted inside the case 100.

The third gear 420 is fixed at one end of the third rotary shaft 410 in such a way as to be engaged with the second gear 320 and is rotated together with the second gear 320 rotating by receiving the driving force from the motor A.

The fourth gear 430 is fixed at one end of the third gear 420 in such a way as to be engaged with the first gear 220 and is rotated together with the second gear 320 rotating by receiving the driving force from the motor A so as to transmit a rotational energy to the first gear 220.

Now, how to operate the auxiliary power apparatus according to the preferred embodiment of the present invention will be described.

When the second rotating member 300 starts to rotate by rotation of the motor A receiving electricity from the outside, the first rotating member 200 and the second rotating member 300 rotate in the same direction with a time difference through the power transmission member 400 which is mounted to be connected with the first rotating member 200 and the second rotating member 300.

In the above-mentioned power transmission process, a process that the first rotating member 200 and the second rotating member 300 are operated will be described. When the second gear 320 which has a gear ratio 1 and is directly connected with the second rotary shaft 310 is rotated by the motor A, the second magnet 350 attached on the inner circumferential surface of the second magnet body 340 is rotated more quickly in the rotational direction. In order to slowly rotate the first magnet 240, which is attached on the outer circumferential surface of the first magnet body 230, in the same direction by the first gear 220 which has a gear ratio 2 (compared with the second gear) and is directly connected with the first rotary shaft 210, the third gear 420 which has the gear ratio 2 or more (compared with the second gear) and rotates integrally with the third rotary shaft 410 engaged with the second gear 320 is rotated in the opposite direction of the rotation according to the characteristics of the rotational direction of gears. Moreover, the fourth gear 430 and the first gear 220 which are rotated integrally are engaged with each other at a velocity ratio of 1:1 so as to be rotated in the same direction as the second gear 320.

Accordingly, the second gear 320 of the second rotating member 300 and the first gear 220 of the first rotating member 200 are rotated in the rotational direction as much as their velocity ratio (more than 2:1 or within an initial phase angle of 90 degrees between the second gear 320 and the first gear 220), such that the second magnet 350 of the second rotating member 300 and the first magnet 240 of the first rotating member 200 are rotated in the same direction with a time difference. Finally, the first magnet 240 attached to the outer circumferential surface of the first magnet body 230 is slowly rotated in the same direction as the second magnet 350. The second magnet 350 which is more in magnetic force and mass is rotated faster but the first magnet 240 which is less in magnetic force and mass is rotated slower. So, when repulsive force and gravitation are changed, there is a change of strength of the magnetic forces of the first magnet 240 and the second magnet 350. Moreover, even though there are repulsive force and gravitation which hinder the mutual rotary motions, the first rotating member 200 and the second rotating member 300 can keep the number of revolutions due to the inertial force to continue rotation overcoming the repulsive force and gravitation.

In this instance, the repulsive force and gravitation generated between the first rotating member 200 and the second rotating member 300 will be described.

When the different poles N and S of the second magnet 350 which is more in magnetic force and mass are rotated, they meet the different poles N and S of the first magnet 240 which is less in magnetic force and mass and rotates slows with the time difference from the second magnet 350. So, when the repulsive force and gravitation act repeatedly, positions of the poles of the second magnet 350 and the poles of the first magnet 240 are changed with time. For instance, compared with the conventional rotating members having repulsive force and gravitation generated when one magnet is rotated in a state where the other magnet is fixed, the first and second rotating members according to the preferred embodiment of the present invention are longer in reaction time and weaker in power to obstruct progress of the second magnet 350 by repulsive force when the second magnet 350 located behind the first magnet 240 becomes closer to the first magnet 240 in a state where the poles of the first and second magnets 240 and 350 are the same or to obstruct progress of the second magnet 350 by gravitation when the second magnet 350 tries to overtake the first magnet 240 in a state where the poles of the first and second magnets 240 and 350 are different. Therefore, according to the laws of motion, a thing with a fast speed of revolution becomes larger in mass and inertia and overtakes a thing with a slow speed of revolution or is more advantageous to lead the thing with the slow speed of revolution. Accordingly, when the thing with the fast speed of revolution is stronger in magnetic force and larger in mass than the thing with the slow speed of revolution, the thing with the fast speed of revolution becomes stronger in power to push or pull.

In the case that the second magnet 350 located behind the first magnet 240 before the pole N (or S) of the second magnet 350 which is more in magnetic force and mass and faster in speed of revolution meets the same pole N (or S) of the first magnet 240 which is less in magnetic force and mass and slower in speed of revolution is obstructed by the repulsive force in progress, due to the fast rotational inertia, the strong magnetic force (repulsive force) and the large mass, the second magnet 350 pushes and overtakes the first magnet 240 having the slow speed of revolution and the less magnetic force and mass. After the same poles of the first magnet 240 and the second magnet 350 meet together, the first and second magnets 240 and 350 are rotated by the action of the less repulsive force of the first magnet 240 and by the reaction of the more repulsive force and the fast rotational inertia of the second magnet 350, and even though there is some obstruction in rotational motion of the magnets 240 and 350 by mutual repulsive forces, the first magnet 240 connected kinematically tries to continue, the rotation of the second magnet 350 through the repulsive force while slowly following the second magnet 350.

On the contrary, in the case that the second magnet 350 located behind the first magnet 240 before the pole N (or S) of the second magnet 350 which is more in magnetic force and mass and faster in speed of revolution meets the different pole S (or N) of the first magnet 240 which is less in magnetic force and mass and slower in speed of revolution is obstructed in progress to pull the first magnet 240 in the opposite direction of the rotation by the strong gravitation, due to the fast rotational inertia, the strong magnetic force (gravitation) and the large mass, the second magnet 350 pulls and overtakes the first magnet 240 having the slow speed of revolution and the less magnetic force and mass while the first magnet 240 receives the power to attract. After the different poles S and N of the first magnet 240 and the second magnet 350 meet together, because the second magnet 350 having the reaction of the more gravitation and the fast rotational inertia pulls the first magnet 240 having the action of the less gravitation, even though there is some obstruction in rotational motion of the magnets 240 and 350 by mutual attraction, the first magnet 240 connected kinematically tries to continue the rotation of the second magnet 350 while slowly following the second magnet 350.

In other words, before the pole N of the second magnet 350 meets the pole N of the first magnet 240, there is attraction, and then, the second magnet 350 which is more in magnetic force and mass and faster in speed of revolution overtakes the first magnet 240 which is less in magnetic force and mass and slower in speed of revolution due to the inertia by the fast speed of revolution. After that, because the second magnet 350 receives the repulsive force from the pole N of the first magnet 240, the second magnet 350 rotates more till meeting the pole S of the first magnet 240.

In this instance, because the pole S of the first magnet 240 also rotates, the pole N of the second magnet 350 which is more in magnetic force and mass and faster in speed of revolution rotates while pulling the pole S of the first magnet 240 having less attraction.

That is, when attraction resistance is reduced due to the abovementioned structure that the first magnet and the second magnet rotate in the same direction with time, the section that the repulsive force acts becomes longer, and thus, the auxiliary power apparatus according to the preferred embodiment of the present invention can keep the number of revolutions better than the conventional auxiliary power apparatus having the known structure.

As described above, the auxiliary power apparatus according to an exemplary embodiment of the present invention can keep the number of revolutions better than the conventional power apparatus by means of magnetic fore (repulsive force and gravitation) acting between the first rotating member and the second rotating member rotating by driving force of the motor.

### INDUSTRIAL APPLICABILITY

The auxiliary power apparatus according to an exemplary embodiment of the present invention can keep the number of revolutions better than the conventional power apparatus by means of magnetic force (repulsive force and gravitation) acting between the first rotating member and the second rotating member rotating by driving force of the motor.

The auxiliary power apparatus according to an exemplary embodiment of the present invention is in expensive, durable and economically feasible and has a simple structure.

1. An auxiliary power apparatus comprising:
a first rotating member (200) including a first magnet (240) having two different poles, the first rotating member (200) being rotatably mounted inside, the case (100);
a second rotating member (300) including a second magnet (350) having two different poles, the second rotating member (300) being mounted rotatably relative to the first rotating member (200) while surrounding the first rotating member (200), the second rotating member (300) being rotated by receiving a driving force from a motor (A); and
a power transmission member (400) connected with the second rotating member (300) and the first rotating member (200), the power transmission member (400) being rotatably mounted inside the case (100) so as to transmit the driving power of the motor (A), which is transmitted to the second rotating member (300), to the first rotating member (200).

2. The auxiliary power apparatus according to claim 1, wherein the first rotating member (200) comprises:
a first rotary shaft (210);
a first gear (220) fixed to one end of the first rotary shaft (210);
a first magnet body (230) of a cylindrical shape mounted at one end of the first gear (220) and fixed to the first rotary shaft (210); and
a first magnet (240) having two different poles and being fixed to the outer circumferential surface of the first magnet body (230).

3. The auxiliary power apparatus according to claim 1, wherein the second rotating member (300) comprises:
a second rotary shaft (310);
a second gear (320) fixed to one end of the second rotary shaft (310);
an inertia plate (330) of a disk form fixed to one end of the second gear (320);
a second magnet body (340) of a cylindrical shape mounted between the inertial plate (330) and the second gear (320), the second magnet body (340) being fixed to the second rotary shaft (310); and
a second magnet (350) fixed to the inner circumferential surface of the second magnet body (340).

4. The auxiliary power apparatus according to claim 1, wherein the power transmission member (400) comprises:
a third rotary shaft (410);
a third gear (420) fixed at one end of the third rotary shaft (410); and
a fourth gear (430) fixed to the third rotary shaft (410) at one end of the third gear (420).
